(19) United States
(12) Patent Application Publication
(10) Pub. No.: US 2017/0239837 A1
(43) Pub. Date: Aug. 24, 2017

(54) POTTER'S WHEEL STAND

(71) Applicant: Carlburg Pottery, LLC, Columbia Falls, MT (US)

(72) Inventor: Tim Carlburg, Columbia Falls, MT (US)

(21) Appl. No.: 15/441,067

(22) Filed: Feb. 23, 2017

Related U.S. Application Data
(60) Provisional application No. 62/299,456, filed on Feb. 24, 2016.

(51) Int. Cl. B28B 1/02; A47B 96/20; A47B 37/00; A47B 9/00

(52) U.S. Cl. CPC B28B 1/025; A47B 9/00; A47B 96/20; A47B 37/00

(57) ABSTRACT

A potter's wheel stand that includes a supporting frame and a vertically adjustable stage with a tray to support a potter's wheel is described. The potter's wheel stand can be configured in free-standing and wall-mounted configurations. The potter's wheel stand can include a backsplash, a plurality of wheels, an integrated overhead lamp, and integrated power outlets or data ports.

### BACKGROUND

### Technical Field

The present disclosure relates generally to stand systems and related methods for supporting and adjusting the height of a potter's wheel, and more particularly to stand systems that allow a user to lower a potter's wheel for use in a sitting position and raise the potter's wheel for use in a standing position.

### Description of the Related Art

Potter's wheels have been used by potters for millennia and continue to be used today. Despite the extensive history and the historical importance of pottery work and potter's wheels, much room for improvement remains. Indeed, despite the continued popularity of pottery work, many basic pottery-work techniques and potter's wheel structures have changed very little over the years. Electric motors have been introduced to modern potter's wheels to reduce the physical burden of their operation, but the primary components such as a rotating wheel mounted on a vertical shaft remain largely unchanged.

Some modern designs for potter's wheels call for a height of the potter's wheel to be adjustable, such as to reduce resulting strain on the potter's back or to allow new groups of people (e.g., those undergoing physical rehabilitation or confined to a wheelchair) to participate in pottery work activities. For example, U.S. Pat. No. 7,195,474 describes systems including potter's wheels with adjustable heights. Despite these modern designs, there still remains much room for improvement in potter's wheels and in the support systems used to hold them.

### BRIEF SUMMARY

The present disclosure is directed to a potter's wheel stand that gives a user an easily utilized option of throwing in a standing or sitting position. This is an ergonomic potter's wheel that allows the user to adjust the stand into a position that is comfortable for the user. The stand includes a platform that is parallel to the ground, where the platform is sized and shaped to support a standard potter's wheel. The platform is supported by a frame and is configured to move up and down the frame to various positions, depending on the height of the user and the desired throwing position. An adjustable backsplash extends perpendicularly from the platform. The frame includes a variety of useful features, such as a lamp, power outlets to plug in the potter's wheel, and a control mechanism for moving the position of the platform.

A system can be summarized as including a frame, a solid rectangular tray that is vertically adjustable with respect to the frame, and a potter's wheel mounted on the tray.

A system can be summarized as including a frame including a first post, a second post, and a third post, the second post positioned between the first post and the third post, a first semi-circular ridge protruding from a surface of the first post, a second semi-circular ridge protruding from a surface of the third post, a stage including a tray and a backsplash, the stage vertically adjustable with respect to the frame, a first flange extending from a first side of the backsplash, the first flange including a first semi-circular groove engaged with the first semi-circular ridge, a second flange extending from a second side of the backsplash opposite to the first side of the backsplash, the second flange including a second semi-circular groove engaged with the second semi-circular ridge, and a potter's wheel mounted on the tray.

The system may further comprise a lamp positioned to shine light down on the tray to illuminate the potter's wheel. The tray and the backsplash may be integrally and rigidly formed with one another. The tray may be fixed in a horizontal plane and the backsplash may be fixed in a vertical plane. The system may further comprise a shelf mounted on the backsplash. The first semi-circular ridge may be a portion of a first cylindrical rod and the second semi-circular ridge may be a portion of a second cylindrical rod. The first semi-circular groove may be formed within a portion of a first cylindrical tube and the second semi-circular groove may be formed within a portion of a second cylindrical tube. The system may be supported on a plurality of wheels. At least one of the plurality of wheels may be a caster wheel. The system may further comprise a plurality of screws that can be turned in a first direction to lift the system off the plurality of wheels, and that can be turned in a second direction opposite to the first direction to lower the system onto the plurality of wheels. The second post may include a plurality of grooves extending vertically along a length of the second post and the stage may include a plurality of ridges engaged with the plurality of grooves.

A potter's wheel support system can be summarized as comprising: a frame including a first post and a second post, a first semi-circular ridge protruding from a surface of the first post, and a second semi-circular ridge protruding from a surface of the second post; and an adjustable stage including a first flange extending from a first side of the adjustable stage and a second flange extending from a second side of the adjustable stage opposite to the first side of the adjustable stage, the first flange including a first semi-circular groove engaged with the first semi-circular ridge, the second flange including a second semi-circular groove engaged with the second semi-circular ridge, the tray vertically adjustable with respect to the frame.

The adjustable stage may hold at least 500 lbs. The adjustable stage may be adjustable over a range of at least 50 inches. The potter's wheel support system may further comprise an outlet that faces downward and a USB port that faces downward.

A support assembly can be summarized as comprising: a first column and a second column; a first ridge protruding from the first column; a second ridge protruding from the second column; a platform that is vertically adjustable with respect to the first and second columns; a first flange extending from the platform and including a first groove engaged with the first ridge; and a second flange extending from the platform and including a second groove engaged with the second ridge.

The platform may be hollow and may include an internal tray that can slide out of the platform. The support assembly may further comprise a first leg removably coupled to the bottom end of the first column and extending horizontally outward from the first column, and a second leg removably coupled to the bottom end of the second column and extending horizontally outward from the second column. The support assembly may further comprise a lumbar support system coupled to the first and second legs.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles may be enlarged and positioned to improve drawing legibility. Further, the particular shapes of the elements as drawn are not necessarily intended to convey any information regarding the actual shape of the particular elements, and may have been solely selected for ease of recognition in the drawings.

FIG. 1 illustrates an oblique view of a potter's wheel stand.

FIG. 2 illustrates a front view of the potter's wheel stand of FIG. 1.

FIG. 3 illustrates a right-side view of the potter's wheel stand of FIGS. 1-2.

FIG. 4 illustrates a rear view of the potter's wheel stand of FIGS. 1-3.

FIG. 5 illustrates a shelf for use with the potter's wheel stand of FIGS. 1-4.

FIG. 6 illustrates another embodiment of a potter's wheel stand.

FIG. 7 illustrates a rear view of the potter's wheel stand of FIG. 6.

FIG. 8 illustrates another embodiment of a potter's wheel stand.

FIG. 9 illustrates another embodiment of a potter's wheel stand.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with the technology have not been shown or described in detail to avoid unnecessarily obscuring descriptions of the embodiments.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

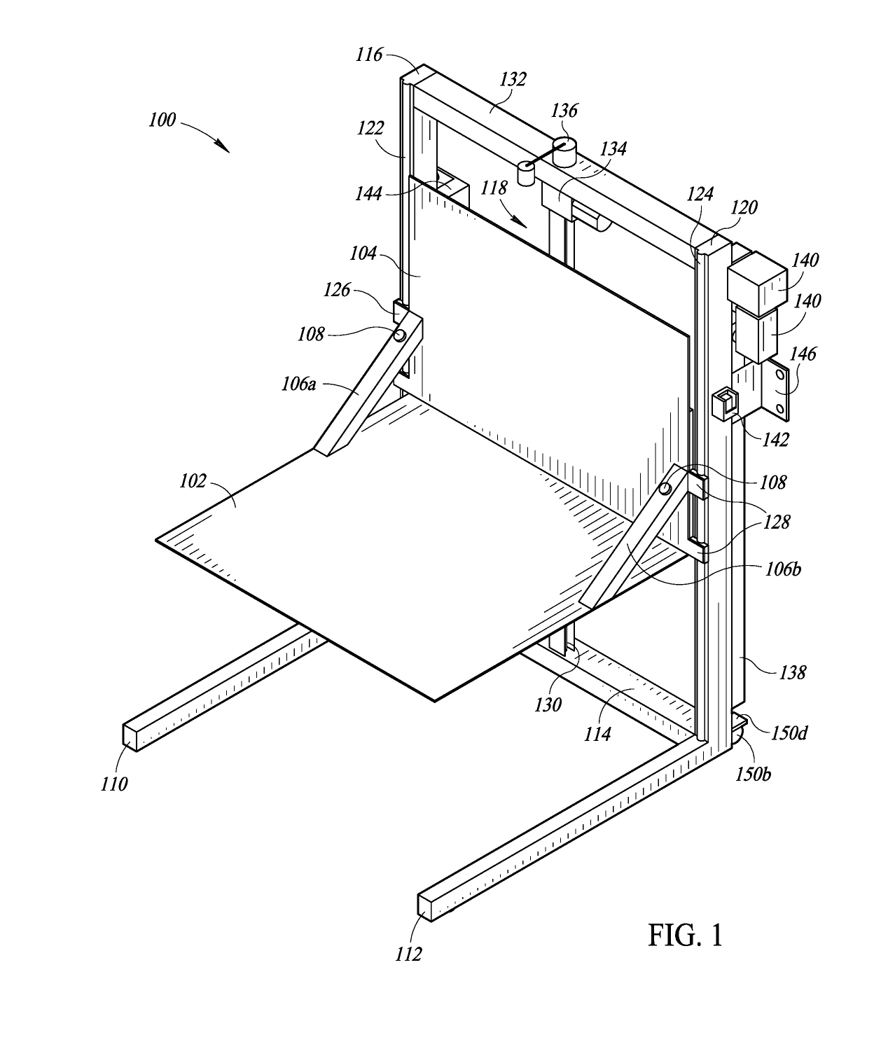

FIG. 1 illustrates a potter's wheel stand 100. The potter's wheel stand 100 includes a work deck, platform, or tray 102 on which a potter's wheel can be positioned and supported for use by a potter. The potter's wheel can include any of various suitable types of potter's wheels, such as an electrically-, pneumatically-, or hydraulically-powered potter's wheel. The tray 102 can include a single, solid, rectangular sheet of material, and can be oriented within a generally horizontal plane. The potter's wheel stand 100 can also include a backsplash 104 arranged at a rear end of the tray 102 to prevent debris from the potter's wheel being cast back toward other components of the potter's wheel stand 100. The backsplash 104 can include a single, solid, rectangular sheet of material, or can be assembled from multiple smaller sheets of material, and can be oriented within a generally vertical plane perpendicular to the horizontal plane of the tray 102.

The tray 102 and backsplash 104 can be formed integrally, such as from a single rectangular sheet of material folded or bent at a right angle at the boundary between the tray 102 and the backsplash 104. In other embodiments, the tray 102 and backsplash 104 can be formed from two distinct pieces of material which are later joined rigidly together, such as by welding or other suitable techniques. In some embodiments, the tray 102 and backsplash 104 can be formed from two distinct pieces of material which are coupled to one another by one or more hinges, such that the tray 102 can rotate about the boundary between the tray 102 and the backsplash 104. In such an implementation, the tray 102 can be folded upwards toward the backsplash 104 to create a more compact configuration for transportation or storage of the potter's wheel stand 100, and the tray 102 can be folded downwards away from the backsplash 104 to allow a potter to position a potter's wheel on the tray 102 for use.

The backsplash 104 may also be formed from several smaller pieces that are adjustable to accommodate various heights. For example, if a potter is very tall and wants to use the potter's wheel stand 100 with the tray 102 in an elevated position, the backsplash 104 can be collapsible to allow for a minimum height of the backsplash 104. As another example, the backsplash 104 may include three sub-panels that can collapse behind a front-most, user-facing panel.

In any of these implementations, the potter's wheel stand 100 can include one, two, or more corner brackets 106, such as the first corner bracket 106a and second corner bracket 106b illustrated in FIG. 1. The corner brackets 106 provide additional strength by coupling the tray 102 at a position outward of the boundary between the tray 102 and the backsplash 104 to the backsplash 104 at a position above the boundary between the tray 102 and the backsplash 104. The corner brackets 106 can be coupled to the tray 102 and the backsplash 104 by any suitable techniques, such as by welding or by using bolts 108. The corner brackets 106 also provide additional support to accommodate weight of the potter's wheel and downward pressure from the potter during use. For example, the potter's wheel stand may be capable of supporting at least 500 pounds.

The tray 102, the backsplash 104, and the corner brackets 106 can form a vertically-adjustable stage that can be controlled by a potter to move vertically from a bottom position, where the top surface of the tray 102 is at ground level or within 1, 2, or 3 inches of ground level, and a top position, where the top surface of the tray 102 is several feet above the ground. This adjustability can allow very short potters (e.g., young children) to use the potter's wheel stand 100 in a seated position, can allow very tall potters to use the potter's wheel stand 100 in a standing position, and can allow any potter to adjust the height of the tray 102 either continuously or incrementally to any position between the top and bottom positions. Potter's wheels have various heights, and depending on the height of the potter's wheel used by the potter, the top of the potter's wheel can be at least as close as one foot to or at least as far as 7 feet from the ground. The height of the tray 102 can be adjusted along a vertical axis such that vertical adjustment of the tray 102 does not also adjust the position of the tray horizontally or angularly. The height of the tray 102 can be adjusted along a vertical axis over a range of at least 50 inches. The tray 102 can have a total thickness (or height) of less than 1″, less than ½, or less than ¼, to allow a top surface of the tray 102 to be lowered closer to ground level than if the tray 102 were thicker.

The remaining components of the potter's wheel stand 100 can form a support frame that supports the stage and allows a potter to adjust the height of the stage. For example, the bottom of the potter's wheel stand 100 can include a left leg 110, a right leg 112, and a bottom cross bar 114. The left and right legs 110, 112 can be coupled to opposing left and right ends of the bottom cross bar 114, respectively, and can extend from the bottom cross bar 114 at right angles to the bottom cross bar 114, to form a generally C-shaped bottom end of the potter's wheel stand 100. The legs 110, 112, and bottom cross bar 114 can be formed integrally with one another or can be formed from separate components that are later coupled to one another. In some implementations, the left and right legs 110, 112 can be removably coupled to the bottom cross bar 114, as discussed further below. The wide base provides room for the user's feet between the legs 110, 112, while providing stable support for the potter's wheel during use. The potter's wheel stand 100 is sturdy and secure to minimize the vibrations that result from the rotation of the potter's wheel during use.

The potter's wheel stand 100 can also include a left post 116, a center post 118, and a right post 120, each extending vertically and at right angles to the bottom cross bar 114. The left post 116 can be coupled to the bottom cross bar 114 where the bottom cross bar 114 is coupled to the left leg 110 and the right post 120 can be coupled to the bottom cross bar 114 where the bottom cross bar 114 is coupled to the right leg 112. The left post 116 includes a semi-circular ridge 122 that extends outwardly from a front surface of the left post 116 and extends vertically along the length of the left post 116. The right post 120 includes a semi-circular ridge 124 that extends outwardly from a front surface of the right post 120 and extends vertically along the length of the right post 120. The center post 118 houses a vertical screw 130, as discussed further below.

One or more guide flanges 126 are coupled to and extend outwardly from the left side of the backsplash 104, and one or more guide flanges 128 are coupled to and extend outwardly from the right side of the backsplash 104. Each of the guide flanges 126, 128 includes a semi-circular groove that extends inwardly into the guide flange 126, 128 from a rear surface of the guide flange 126, 128 and extends vertically along the length of the guide flange 126, 128. The semi-circular grooves of the guide flanges 126, 128 are positioned to engage with the semi-circular ridges 122, 124 to guide the vertical movement of the stage with respect to the frame. In one implementation, the potter's wheel stand 100 includes vertical rods coupled to the left and right posts 116, 120, in place of the semi-circular ridges 122, 124, and ¾ of a tube coupled to both the guide flanges 126 and the guide flanges 128 in place of the semi-circular grooves. In such an implementation, the ¾ tubes can be engaged with the rods to guide the vertical movement of the stage with respect to the frame.

The frame of the potter's wheel stand 100 can further include a top cross bar 132 that is coupled at its left end and at a right angle to a top end of the left post 116, is coupled at its center and at a right angle to a top end of the center post 118, and is coupled at its right end and at a right angle to a top end of the right post 120. The potter's wheel stand 100 also includes an electric motor 134 coupled to the top of the center post 118 and coupled to the bottom surface of the top cross bar 132. In one alternative implementation, the electric motor 134 can be coupled instead to the bottom of the center post 118 and to a top surface of the bottom cross bar 114. The potter's wheel stand 100 also includes an overhead lamp 136 that is positioned to shine light down on the tray 102 from above to illuminate the potter's wheel to assist the potter. The moveable parts of the motor 134 are enclosed within a sealed container to avoid any risk of harm to the user.

The potter's wheel stand 100 also includes a cable housing 138 that is coupled to and runs vertically along a rear surface of the right post 120, as well as one or more electrical boxes 140 coupled to the right post 120 near the top end of the right post 120. Cables and wires, such as cables or wires carrying electrical power or data, can extend from an outlet, upward through the cable housing 138, to the electrical boxes 140, where they can provide power or data connections for other components of the potter's wheel stand 100. The potter's wheel stand 100 also includes an electric switch 142 that can allow a potter to control the motor 134, such as to switch the motor 134 on and off or to control a direction the motor 134 turns the screw 130, as described further below.

In one example, the electrical boxes 140 include four GFCI outlets and two USB outlets. A power cable can be plugged into a standard wall outlet, can extend upward through the cable housing 138, and can be coupled to a corresponding standard outlet or set of outlets in the electrical boxes 140 to allow a potter to plug in the motor 134, lamp 136 and any other items drawing electrical power. Further, a USB or other data cable can be plugged into a data port of a computer, router, or other device, can extend upward through the cable housing 138, and can be coupled to a corresponding USB or other data port or plurality of ports in the electrical boxes 140 to allow a potter to plug in a digital device such as a speaker, smartphone, or tablet to play music, play instructional pottery videos, or play other media for use or enjoyment.

The electrical boxes 140 may include a retractable cover and openings through which wires can extend to prevent clay dust from entering the outlets. The openings may be positioned on a downward facing side or may face a back side of the potter's wheel stand 100. The electrical boxes 140 are affixed to the right post 120 with screws or other attachment means, such as adhesive, support prongs, or other equivalents.

The potter's wheel stand 100 also includes a left mounting flange 144 rigidly and removably coupled to and extending outwardly away from the left post 116 and a right mounting flange 146 rigidly and removably coupled to and extending outwardly away from the right post 120. In one alternative implementation, two mounting flanges can be coupled to the bottom cross bar 114 and two mounting flanges can be coupled to the top cross bar 132. For example, a first mounting flange can be coupled near a left end of the bottom cross bar 114, a second mounting flange can be coupled near a right end of the bottom cross bar 114, a third mounting flange can be coupled near a left end of the top cross bar 132, and a fourth mounting flange can be coupled near a right end of the top cross bar 132. The mounting flanges 144, 146 can allow a potter to mount the potter's wheel stand 100 to a wall if desired. Thus, the potter's wheel stand 100 can be used in at least two different configurations: a first, free-standing configuration, and a second, wall-mounted configuration.

In the first configuration, a potter can leave the removable legs 110, 112 attached to the rest of the potter's wheel stand 100 and remove the mounting flanges 144, 146 from the rest of the potter's wheel stand 100. The potter can then use the potter's wheel stand 100 in the free-standing configuration, in which the potter can move completely around the potter's wheel stand 100 and move the potter's wheel stand 100 across the ground 100. In the second configuration, a potter can leave the mounting flanges 144, 146 attached to the rest of the potter's wheel stand 100 and remove the legs 110, 112 and wheels 48a, 48b, 50a, 50b, as discussed further below, from the rest of the potter's wheel stand 100. For example, the legs 110, 112 can be coupled to the bottom cross bar 114 in a male/female connection secured by a cotter pin or other suitable screw or mechanism. The potter can then mount the potter's wheel stand 100 to a wall, such as by using bolts extending through openings in the mounting flanges 144, 146, and use the potter's wheel stand 100 in the wall-mounted configuration.

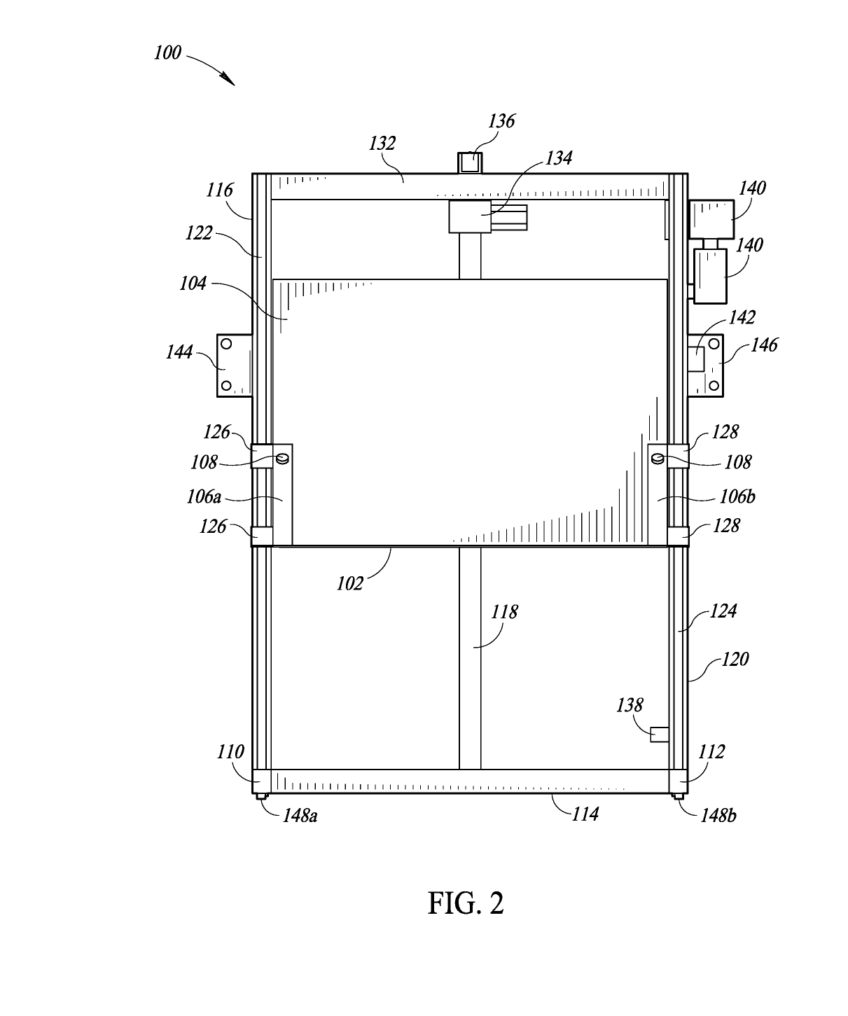

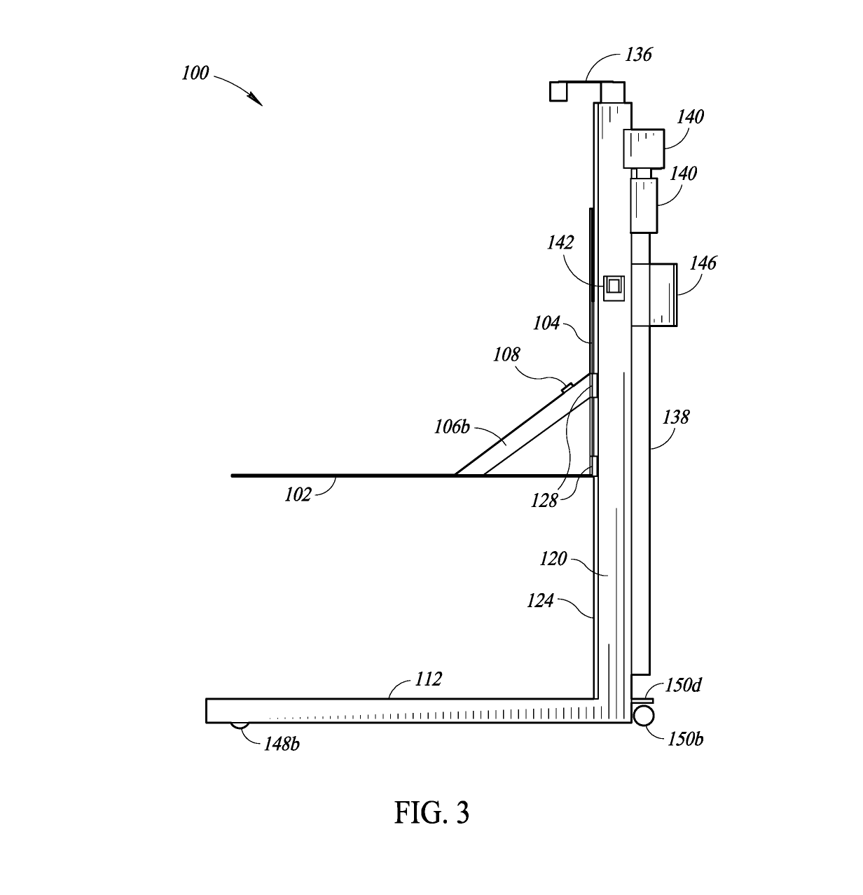

FIG. 2 illustrates a front view of the potter's wheel stand 100. FIG. 3 illustrates a right-side view of the potter's wheel stand 100. As illustrated in FIG. 3, the potter's wheel stand 100 includes wheels coupled to the potter's wheel stand 100 at the four corners of the bottom end of the potter's wheel stand 100. For example, FIG. 3 illustrates that the potter's wheel stand 100 includes a right-side front wheel 148b coupled to a front end of the right leg 112 and a right-side rear wheel 150b coupled to a rear end of the right leg 112. Further, the potter's wheel stand 100 includes a left-side front wheel 148a coupled to a front end of the left leg 110 and a left-side rear wheel 150a coupled to a rear end of the left leg 110.

The wheels 148a, 148b, 150a, and 150b can include caster wheels with brakes, and can allow a potter to move the potter's wheel stand 100 across the floor within a workspace. The rear wheels 150a, 150b can be coupled to support flanges 150c, 150d, respectively, which can be coupled to and extend rearward from the left and right posts 116, 120, respectively. The potter's wheel stand 100 can further include screws that are screwed vertically into one or more of the legs 110, 112, and the bottom cross bar 114. Once a potter has positioned the potter's wheel stand 100 in a desired location within a workspace, the potter can turn these screws so they travel downward through the legs 110, 112, or the bottom cross bar 114, to raise the rest of the potter's wheel stand 100 up off of the wheels 148a, 148b, 150a, 150b, to provide the potter's wheel stand 100 with a more stable base.

The front wheels 148a, 148b may be omitted and the rear wheels 150a, 150b may be the only wheels provided. In such an embodiment, the potter's wheel stand 100 would be movable by tipping the potter's wheel stand 100 backwards towards the rear wheels 150a, 150b, and rolling from there.

FIG. 3 also illustrates that the legs 110 and 112 extend further forward than the tray 102, which can increase the stability of the potter's wheel stand 100. In other implementations, the tray 102 can extend further forward than the legs 110 and 112, which can facilitate a potter's access to a potter's wheel positioned on the tray 102. In other implementations, the left leg 110 extends forward and outward to the left from the bottom crossbar 114 and the right leg 112 extends forward and outward to the right from the bottom crossbar 114, so that the legs 110, 112 diverge from one another as they extend forward. Such an implementation can also facilitate a potter's access to a potter's wheel positioned on the tray 102.

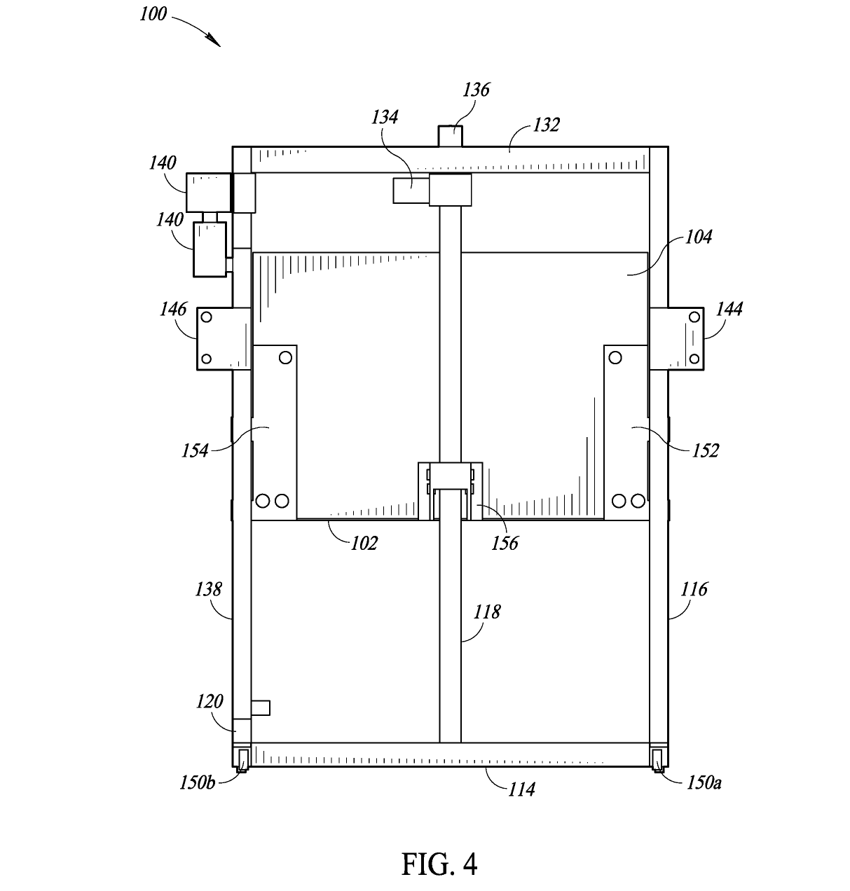

FIG. 4 illustrates that the guide flanges 126 are portions of a support plate 152 that is coupled to a rear surface of the backsplash 104, and that extend laterally outward from the backsplash 104 to engage the ridge 122 as described above. FIG. 4 also illustrates that the guide flanges 128 are portions of a support plate 154 that is coupled to a rear surface of the backsplash 104, and that extend laterally outward from the backsplash 104 to engage the ridge 124 as described above. The guide flanges 126 or the guide flanges 128 can also be formed from one solid piece of material that extends between the pair of illustrated guide flanges 126 or 128. A backsplash 104-free version of the potter's wheel stand 100 can include the guide flanges 126, 128 attached to the tray 102.

FIG. 4 further illustrates that the potter's wheel stand 100 includes a nut housing 156 coupled to the rear surface of the backsplash 104. The nut housing 156 extends outwardly and rearward from the backsplash 104 and includes a loop portion that surrounds and engages with the center post 118. The nut housing 156 houses and is rigidly coupled to a nut such that the nut is rotationally locked with respect to the nut housing 156. The nut is threadedly engaged on the vertical screw 130 within the center post 118, such that rotation of the vertical screw 130 causes the nut, which cannot rotate with the vertical screw 130 because it is rotationally locked to the nut housing 156, to travel vertically along the vertical screw 130. As the nut travels vertically along the vertical screw 130, it carries the nut housing 156 and thus the vertically adjustable stage including the tray 102 and backsplash 104 up or down with it.

In some embodiments, the potter's wheel stand 100 can be operated as follows. First, a potter can install the potter's wheel stand 100 in either of the free-standing or the wall-mounted configurations. The potter can then plug in a power cable of the potter's wheel stand 100 to a standard wall outlet. The potter can then plug the motor 134 into an outlet of one of the electrical boxes 140 to provide power to the motor and cause the motor to rotate the vertical screw 130. The potter can operate the switch 142 to select or control the direction in which the vertical screw 130 rotates, which can be referred to as “one-touch control” of the vertical screw 130. The potter can allow the motor to turn the vertical screw 130 to raise or lower the tray 102 until the top surface of the tray 102 reaches a desired elevation, at which point, the potter can unplug the motor 134 to stop the rotation of the vertical screw 130 and the vertical movement of the tray 102. The potter can then install a potter's wheel on the tray 102, plug the potter's wheel into an outlet of one of the electrical boxes 140, and then begin using the potter's wheel.

The components of the potter's wheel stand 100 can be formed from any suitable materials. For example, the deck 102 and backsplash 104 can be formed from stainless steel. The frame, including the legs 110, 112, cross bars 114, 132, and posts 116, 120, can be formed from high-strength, powder-coated tube steel, and the cable housing 138 can be formed from PVC pipe.

The tray 102 and the backsplash 104 are formed from smooth, low-texture material that allows for easy cleaning, such as stainless steel. The tray 102 may be four feet by four feet to accommodate a standard potter's wheel, while allowing the potter's wheel stand 100 to fit through a standard 36 inch door when turned on its side.

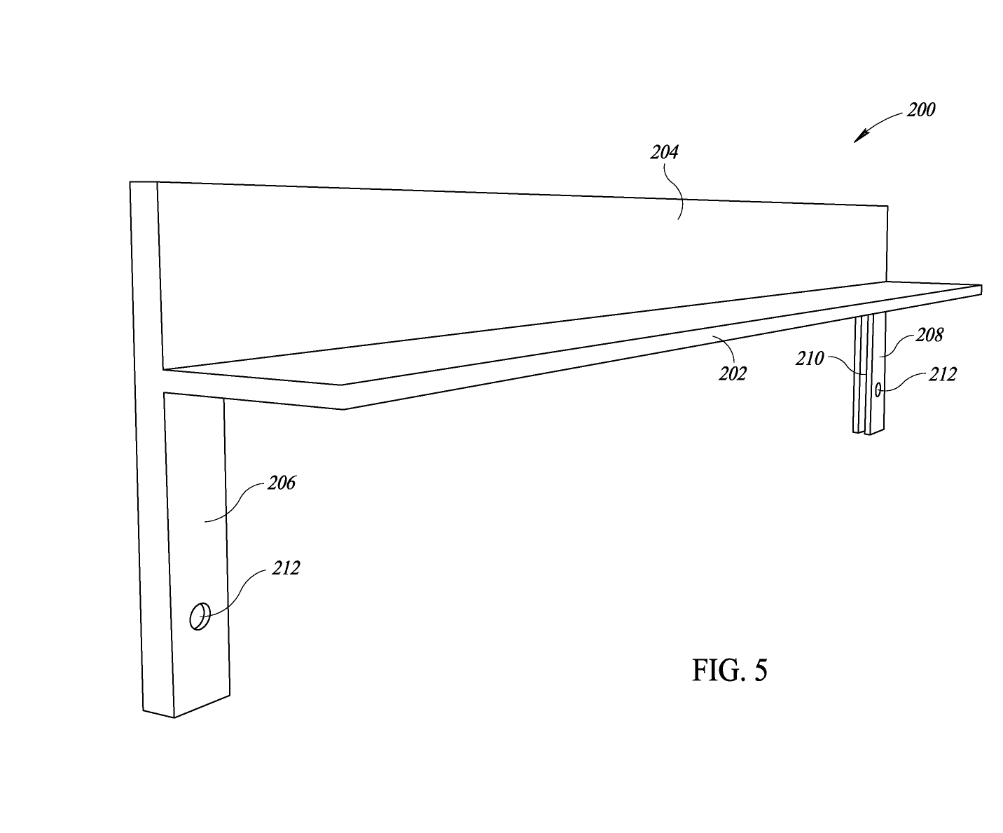

FIG. 5 illustrates a shelf 200 for use with the potter's wheel stand 100. The shelf 200 includes a horizontal tray 202, a vertical backsplash 204, a left leg 206, and a right leg 208. The right leg 208 includes an inward-facing groove 210 and the left leg 206 includes a corresponding inward-facing groove that is not visible in FIG. 5. The legs 206, 208 and the corresponding inward-facing grooves are spaced apart from one another by a distance corresponding to a width of the backsplash 104. The shelf 200 can be positioned on a top portion of the backsplash 104 by sliding the inward-facing grooves of the legs 206, 208 over the top portion of the backsplash 104, and the shelf 200 can be secured to the top portion of the backsplash 104 by using clamps or bolts extending through apertures 212 in the legs 206, 208. A potter can use the shelf 200 to hold items such as a speaker, phone, keys, wallet, etc., to separate the items from any debris from the potter's wheel.

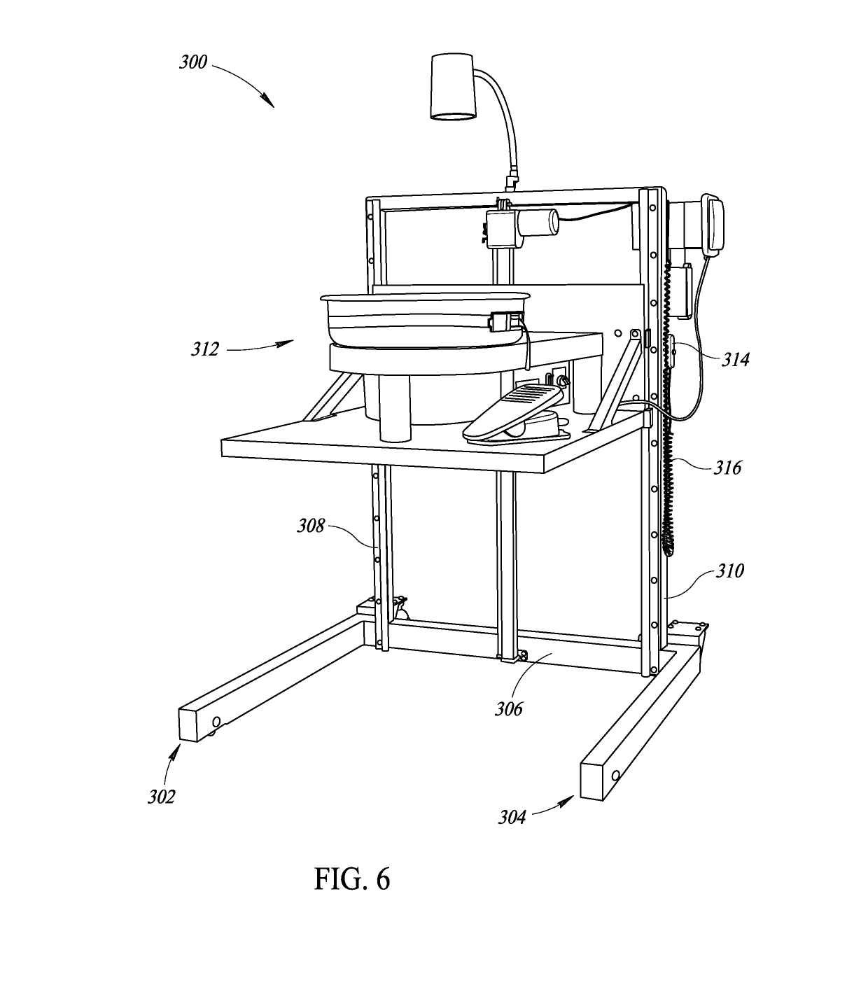

FIG. 6 illustrates another embodiment of a potter's wheel stand 300 which is similar in many respects to the potter's wheel stand 100. Potter's wheel stand 300 includes a left leg 302 and a right leg 304, each of which are coupled to a bottom crossbar 306 at locations spaced outward with respect to a left post 308 and a right post 310. Such an arrangement can increase the stability of the potter's wheel stand 300 and facilitate a potter's access to a potter's wheel 312 positioned on the potter's wheel stand 300. The potter's wheel stand 300 also includes a controller 314 coupled to the potter's wheel stand 300 by a coiled cable 316 in place of the switch 142. Such an arrangement can allow a potter to control operation of the potter's wheel stand 300 from a greater range of positions. For example, a potter can control a height of the potter's wheel 312 without leaving a position in front of the potter's wheel 312.

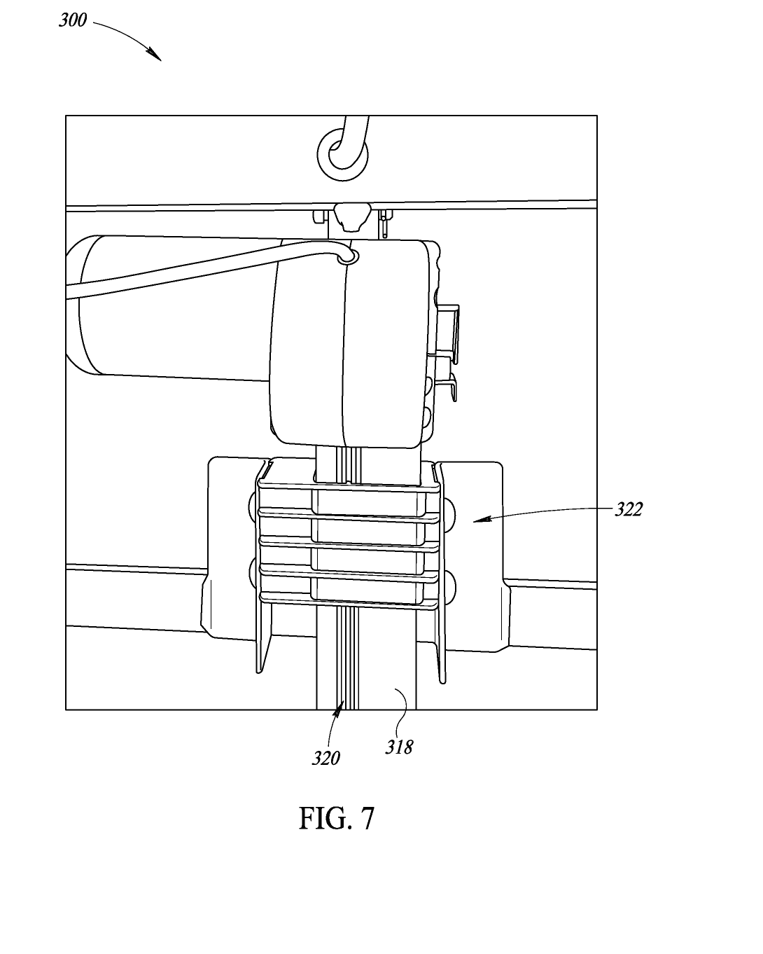

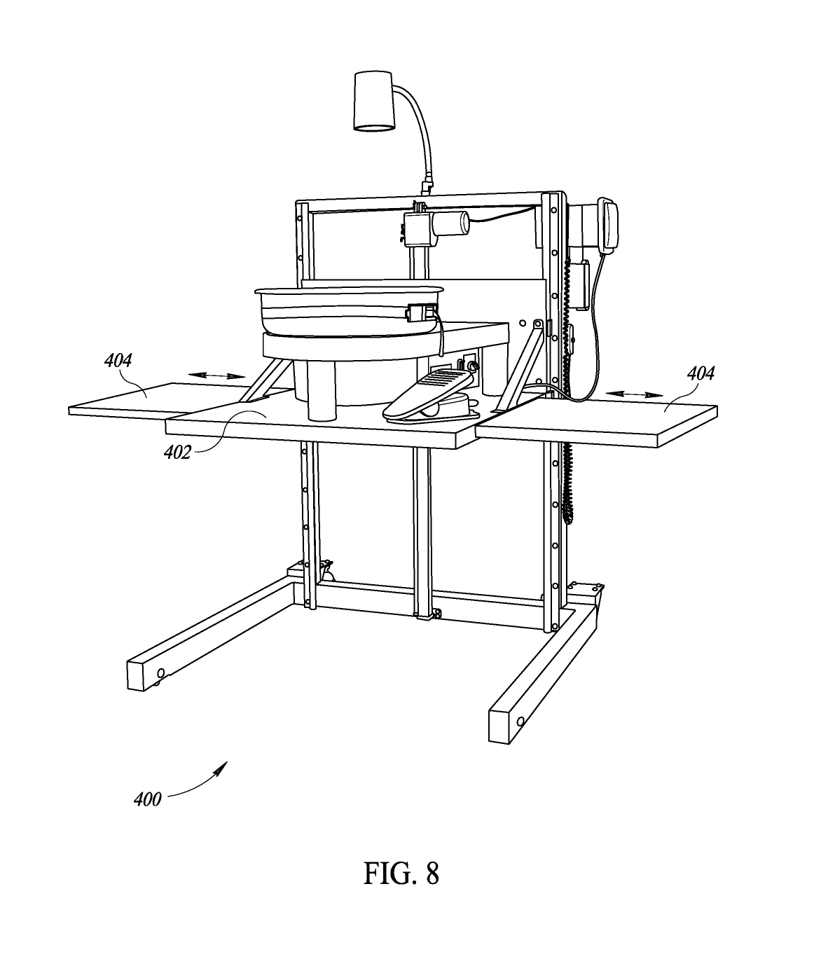

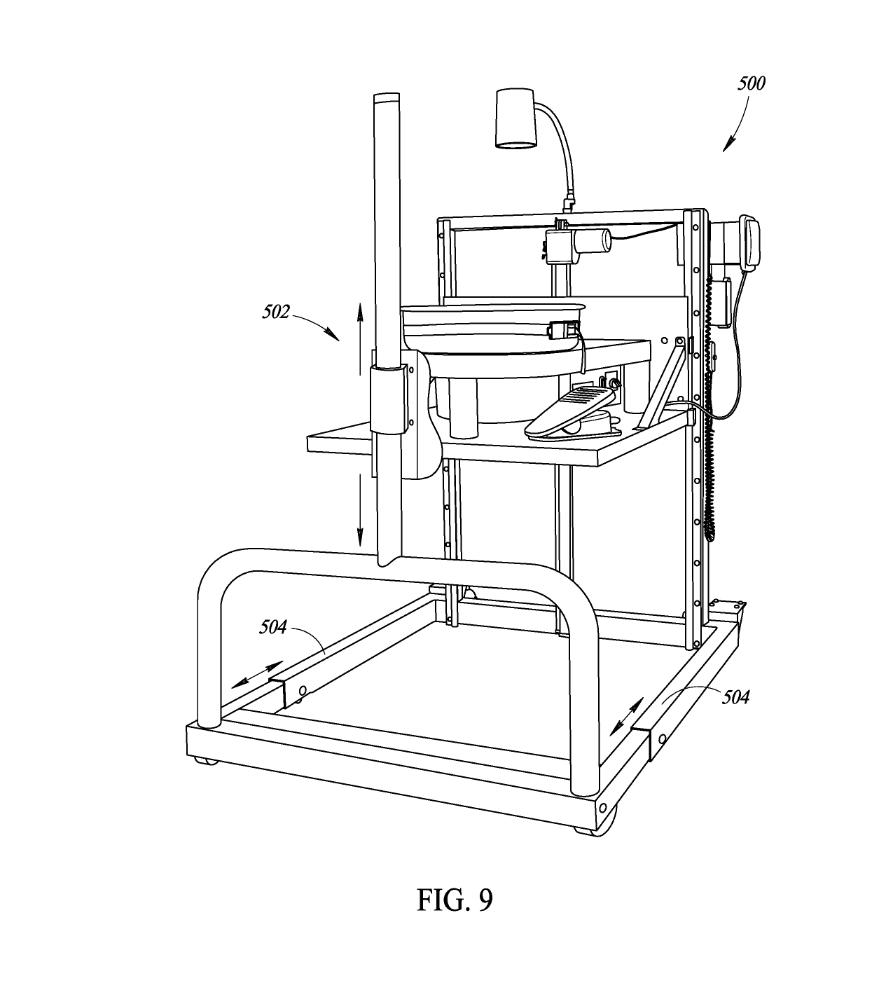

FIG. 7 illustrates a rear view of the potter's wheel stand 300. As seen in FIG. 7, a center post 318 can include a plurality of grooves 320 extending vertically along its length. Corresponding ridges or teeth formed in a nut housing 322 can engage with the grooves 320 to facilitate smooth motion of the nut housing 322 with respect to the center post 318. FIG. 8 illustrates another embodiment of a potter's wheel stand 400, in which a tray 402 is hollow and includes a plurality of internal trays 404 that a potter can slide out of the tray 402 to expand a working area of the potter's wheel stand 400. As one alternative, the tray 402 can be solid rather than hollow, and the trays 404 can be separate, stand-alone components that can be coupled, such as by mechanical fasteners such as bolts and/or set screws, to sides of the tray 402. FIG. 9 illustrates another embodiment of a potter's wheel stand 500, in which a lumbar support system 502 is coupled to the potter's wheel stand 500, to support a potter's back while using a potter's wheel on the potter's wheel stand 500. For example, the lumbar support system 502 is coupled to left and right legs 504 of the potter's wheel system 500.

U.S. provisional patent application No. 62/299,456, filed Feb. 24, 2016, to which this application claims priority, is hereby incorporated herein by reference in its entirety. The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system comprising:
a frame including a first post, a second post, and a third post, the second post positioned between the first post and the third post;
a first semi-circular ridge protruding from a surface of the first post;
a second semi-circular ridge protruding from a surface of the third post;
a stage including a tray and a backsplash, the stage vertically adjustable with respect to the frame;
a first flange extending from a first side of the backsplash, the first flange including a first semi-circular groove engaged with the first semi-circular ridge;
a second flange extending from a second side of the backsplash opposite to the first side of the backsplash, the second flange including a second semi-circular groove engaged with the second semi-circular ridge; and
a potter's wheel mounted on the tray.

2. The system of claim 1, further comprising a lamp positioned to shine light down on the tray to illuminate the potter's wheel.

3. The system of claim 1 wherein the tray and the backsplash are integrally and rigidly formed with one another.

4. The system of claim 3 wherein the tray is fixed in a horizontal plane and the backsplash is fixed in a vertical plane.

5. The system of claim 1, further comprising a shelf mounted on the backsplash.

6. The system of claim 1 wherein the first semi-circular ridge is a portion of a first cylindrical rod and the second semi-circular ridge is a portion of a second cylindrical rod.

7. The system of claim 6 wherein the first semi-circular groove is formed within a portion of a first cylindrical tube and the second semi-circular groove is formed within a portion of a second cylindrical tube.

8. The system of claim 1 wherein the system is supported on a plurality of wheels.

9. The system of claim 8 wherein at least one of the plurality of wheels is a caster wheel.

10. The system of claim 9, further comprising a plurality of screws that can be turned in a first direction to lift the system off the plurality of wheels, and that can be turned in a second direction opposite to the first direction to lower the system onto the plurality of wheels.

11. The system of claim 1 wherein the second post includes a plurality of grooves extending vertically along a length of the second post and the stage includes a plurality of ridges engaged with the plurality of grooves.

12. A potter's wheel support system comprising:
a frame including a first post and a second post, a first semi-circular ridge protruding from a surface of the first post, and a second semi-circular ridge protruding from a surface of the second post; and
an adjustable stage including a first flange extending from a first side of the adjustable stage and a second flange extending from a second side of the adjustable stage opposite to the first side of the adjustable stage, the first flange including a first semi-circular groove engaged with the first semi-circular ridge, the second flange including a second semi-circular groove engaged with the second semi-circular ridge, the tray vertically adjustable with respect to the frame.

13. The potter's wheel support system of claim 12 wherein the adjustable stage can hold at least 500 lbs.

14. The potter's wheel support system of claim 12 wherein the adjustable stage is adjustable over a range of at least 50 inches.

15. The potter's wheel support system of claim 12, further comprising an outlet that faces downward and a USB port that faces downward.

16. A support assembly comprising:
a first column and a second column;
a first ridge protruding from the first column;
a second ridge protruding from the second column;
a platform that is vertically adjustable with respect to the first and second columns;
a first flange extending from the platform and including a first groove engaged with the first ridge; and
a second flange extending from the platform and including a second groove engaged with the second ridge.

17. The support assembly of claim 16 wherein the platform is hollow and includes an internal tray that can slide out of the platform.

18. The support assembly of claim 16, further comprising a first leg removably coupled to the bottom end of the first column and extending horizontally outward from the first column, and a second leg removably coupled to the bottom end of the second column and extending horizontally outward from the second column.

19. The support assembly of claim 18, further comprising a lumbar support system coupled to the first and second legs.
